(19) United States
(12) Patent Application Publication
(10) Pub. No.: US 2010/0071335 A1
(43) Pub. Date: Mar. 25, 2010

(54) "PLANTS PROCESSOR AND CROP HEADS SEPARATOR DEVICE FOR COMBINE HARVESTERS"

(76) Inventor: Jose Luis POEYLAUT, Pcia de Santa Fe (AR)

Correspondence Address: DEFILLO & ASSOCIATES, INC., P.O. Box 14104, Clearwater, FL, 33766, US

(21) Appl. No.: 12/548,557

(22) Filed: Aug. 27, 2009

(30) Foreign Application Priority Data
Sep. 25, 2008 (AR) P080104160

(51) Int. Cl. A01D 45/02

(52) U.S. Cl. 56/94

(57) ABSTRACT

Plants processor and crop heads separator device for combine harvesters, preferably applicable in corn and sunflower crops, and adaptable to row crop harvesting headers currently under use, composed by at least one roll with its rotational axis positioned in angle as regards the forward movement of the header. This device is applicable to combine harvesters equipped with a row crop harvesting header with gathering zones, each of which has one, two, three or more rotating rolls and with a special feature as the rotational axes of the said rolls positioned in angle as regards the forward movement of the combine harvester and where at least one of them rotates opposite to the forward movement of the combine harvester.

### FIELD OF APPLICATION

The present invention refers to a plants processor and crop head separator device for combine harvesters, preferably applicable in corn and sunflower crops, and adaptable to corn headers currently under use, this device is composed by at least one roll with its rotational axis positioned in angle as regards the forward movement of the header.

### PRIOR ART AND ADVANTAGES OF THE INVENTION COMPARED TO IT

It is widely known that crop heads harvesting involves the following stages as basic principles: stage a) processing the plants, that is exploring the whole plant in search for crop heads, leaving the plant on the ground in optimal conditions for their integration with the soil, avoiding the entry of material that is not part of the crop heads to its processing systems (stalks, leaves, weeds, etc.); stage b) separating the crop head from the other parts of the plant; and finally stage c) gathering the crop head.

In the present specifications, there will be repeated references to stalk rolls or simply to the rolls, that are one of the main elements constituting the current systems and the reason for the present invention. In most cases, three surfaces can be clearly identified on the rolls, see FIG. 10, two on the end sections and one on the central section, hereinafter, these surfaces will be designated as rare face 3, to the one located in the end connected to the shaft 4, side face 2, to the one located on the central section, and front face 1, to the one located on the free end. It will also be necessary to differentiate some of the rolls by its rotation direction as regards the forward movement of the header. Those rotating in a forward-like direction will hereinafter be designated as normal rotation rolls or normal rolls, and those rotating in the opposite direction will hereinafter be designated rolls rotating in opposite direction or opposite rolls. As an example, the wheels of the combine harvester have a normal rotation when the combine harvester moves forward and an opposite rotation when the combine harvester moves backwards.

On a study carried out by the National Institute of Agricultural Technology in Argentine (INTA for its initials in Spanish) about grain loss in the corn harvest, two factors related to the combine harvester are highlighted: ground speed and adjustment of the stripper plates. These are of great importance when it comes to lowering the grain loss caused by the corn header.

This study informs that if there is an excessive ground speed, the corn header will pull the ears off the stalk in the rear part of the stripper plates, piling up several ears at the same time and causing some to fall in front of the header and others to suffer loss of seeds. Ideally, the ear should be pulling off the stalk at half way in the gathering chains. Once the speed issue has been solved, the space between the stripper plates edges will have to be correctly adjusted, which will be determined in relation to the stalks diameter and the size of the ears. If these two factors are uniform in the crop, the header adjustment is simple, but if any of these two factors are not uniform in the row, the stripper plates adjustment will not be a simple matter to solve. A practical rule for the adjustment of stripper plates is beginning to operate with the stripper plates as close as possible and then opening them until the combine harvester does not get stuck often.

The prior art ears separating systems feature rolls whose rotational axes are placed or positioned parallel to the header forward movement. We will designate those rolls as lateral rolls.

The lateral rolls with gear-like teeth, flutes or drivers, overlap those teeth, flutes or drivers edges in a synchronized fashion, they are cylindrical or rectangular in the rear end, mainly tapered with helical flightings all along or in the front end. These helical flightings are capable of taking in the plant between the rolls and thus facilitating the flow among them. Some lateral rolls systems feature stripper plates to protect the ears from the aggressiveness of the rolls.

The plant processor and crop heads separator device in the present invention featuring specially positioned rolls, hereinafter designated transverse rolls, fully meets the three principles previously stated and it will be explained in the following paragraphs.

In FIG. 1, it is possible to observe a conventional corn header for lateral rolls 5, as the ones known in the prior art until today, featuring 90° gearboxes 6. For every pair of rolls 7 a 90° gearbox 6 is necessary, this gearbox with oil bath gear drives and bearings requires precision tooling and consists, at least, of three transmission gears and shafts where the rolls 7 are mounted. The whole kit has a high cost and a considerable weight, which, in headers with large amounts of rows, causes problems at the structural level and stability of the combine harvester.

FIG. 2, shows a corn header 8 with transverse rolls 9 & 10 according to an initial preferred realization mode of the present invention in a three-engaged-rolls configuration, it can be noticed that there are not 90° gearboxes 6, the only moving parts are the shafts 11 and the rolls themselves, in this case, one normal roll 10 and two opposite rolls 9, the building simplicity and the disposal of the 90° gearboxes 6 allow for the saving of material, manpower and equipment weight.

FIG. 3 shows a second preferred realization mode of the present invention, a corn header 12 with transverse rolls in a two-opposite-rolls configuration with two opposite rolls 13 against anti-friction fixed plate 14 and a shaft 15 providing drive belts 16 with counter rotating movement 17. The lack of 90° gearboxes 6 can be noticed; the only moving parts are the shafts, the rolls, the pulleys and the belts.

FIG. 4 shows a corn header 18 with transverse rolls according to a third preferred realization mode of the present invention, in an one-opposite-roll configuration with one opposite roll 19 against anti-friction fixed plate 20 and a shaft 21 providing drive belts 22 with counter rotating movement 23. The lack of 90° gearboxes 6 can be noticed; the only moving parts are the shafts, the rolls, the pulleys and the belts.

The header configurations with transverse rolls mentioned before are some of the preferred realization modes but not all the possible ones. It should be noted that the 90° gearboxes, used by lateral rolls known until today, have been eliminated in all of them.

One of the advantages of this configuration of transverse rolls usage over the known lateral rolls is the possibility of increasing the roll diameter and/or rolls rotational speed without increasing the shearing action of the gathering chains and without the rolls pushing the stalks or cutting the plants.

The increase in the roll diameter and/or speed of rotation causes an increase in the tangential speed of the pulling surfaces of the rolls which increases the number of lineal meters of stalks and the number of ears processed by the different systems.

In a theoretical comparison between the transverse roll system 24 of the present invention and the prior art lateral roll system 25, where the operational variables are the same for both systems and where the only difference lies in the transverse rolls diameter, which is 50% larger than the lateral rolls, the increase in the tangential speed could be achieved by increasing the rotation speed or a combination of both, but for this comparison, the diameter is enough. The 5 km/h speed is drawn from the INTA report about the corn harvest where it is taken as the maximum optimal speed for lateral systems (3.5 km/h to 5 km/h), the 10 km/h speed is considered as the maximum speed above which the process capacity of the combine harvester could be affected, where the double amount of ears and crop residue would be processed by unit of time.

The ideal performance of transverse rolls 24 featuring 150 mm diameter rolls rotating at 1500 RPM, plant 26 distance of 200 mm, an estimated of 2000 mm of stalk to be processed per plant and one ear 27 per plant located at 1000 mm of the ground; Transverse roll perimeter: P=471 mm; Revolutions per second: 25; I=200 mm and 5 km/h ground speed as shown in FIG. 5a.

In the “I” interval, the transverse roll rotated 4.1 times, which equals 1932 mm of processed stalk, the first plant was processed along with its ear before the second plant entered the system.

At 10 km/h ground speed, FIG. 5b, in the interval “I” the transverse roll rotated 2.05 times which equals 966 mm of processed stalk, the system must run two intervals to complete the process of the first stalk, when the second plant enters the roll system, the ear of the first is separated from the plant and then the last meter of the first stalk along with the first meter of the second stalk coexist inside the system. By the time the third stalk enters, the second stalk is separated from the ear and the first one comes out completely. This shows that there are always two plants and only one ear being processed inside the system.

Now, the ideal performance for a lateral rolls system 25 (FIG. 5c) with 100 mm diameter rolls rotating at 1500 RPM, plant 26 distance of 200 mm, an estimated of 2000 mm of stalk to be processed per plant and one ear 27 per plant located at 1000 mm of the ground. Lateral roll perimeter: P=314 mm; Revolutions per second: 25, I=200 mm and 5 km/h ground speed.

In the “I” interval, the lateral roll rotated 4.1 times which equals 1290 mm of processed stalk, still remaining 700-mm to be processed from the first plant by the time the second enters the roll system. The ear of the first plant was processed before the ear of the second plant entered the system.

At 10 km/h ground speed, FIG. 5d, in the interval “I” the lateral roll rotated 2.05 times which equals 645 mm of processed stalk. In order to complete the process of the first stalk, the system must run three intervals, this means that following the reasoning used in the analysis of the transverse rolls performance, within the lateral rolls system, three stalks and two ears are always being processed.

From the performance of the two systems 24 & 25 it is concluded that at a ground speed of 5 km/h, the two systems practically process the same amount of stalks and ears (one stalk and one ear) but at 10 km/h, the lateral rolls 25 system must process an extra 50% of stalks and an extra 100% of ears than those processed by the transverse rolls 24 (3 stalks and 2 ears against 2 stalks and 1 ear of the transverse rolls 24). It is worth remembering that the lateral rolls system 25 can neither freely increase the roll diameter nor its rotation speed due to the pushing and dragging effect over the stalks and the limited space between rows.

With these initial parameters, a system of transverse rolls 24 at a ground speed of 7.5 km/h, processes the stalks and the ears in the same way (but at higher speed) than a lateral roll system 25 at 5 km/h, that is, a ear and 1290 mm of stalk are processed before the second stalk enters the system, an extra 50% in direct relation with the increase of diameter.

The performance of a stalk roll system, of any type, can be divided into three stages: stage a) In taking the stalk between the rolls so that it can be pulled, stage b) pulling down the stalk with a good enough grip to remove the crop head without cutting it up, and stage c) removing the crop head from the plant. At this stage, the systems are divided between those that separate the crop head directly over the roll surface and those that separate the crop head using stripper plates. These stripper plates are positioned above the rolls avoiding the passing of the crop heads between the stripper plates edges and separating them from the stalk by the pulling of the rolls.

The prior art lateral rolls with their conic elongated bodies, working in pairs, rotate in opposite directions in a synchronized and engaged manner (see FIG. 6) and can be divided mainly in two parts, a conic end 29 with one or several helical flightings 30 & 31 that are properly out-of-phase each others, and a straight or slightly conic body 32, with flutes or drivers 33, that may or may not have one or several helical flightings to favor the stalks and ears flow.

The lateral rolls require a synchronized and engaged rotation, this is a very important factor and everything is designed and built in order to ensure this, that is to say: The 90° gearboxes, the splined shafts, the flutes or drivers and helical flightings in their building and their assembly position, the rolls with joints threaded to the 90° gearboxes are assembled with high tightening torques to avoid movement during their operation. Synchrony failures can produce contact between rolls, breakage, premature wear, stalk cuts and jamming, among others.

On the other hand, the transverse rolls, such as those shown in the present invention (see configuration FIG. 7), have a cylindrical body of variable geometry 35, similar to a wheel or pulley, divided in two working zones or surfaces, the front face 36 positioned aside the stalk access 37 and the side face 38 practically faced to the stalks entering the system 37, their rotations are even, not necessarily synchronized nor engaged, both rotating in opposite direction to the header forward movement.

In order to accomplish stage “a”, the lateral roll systems 28 (FIG. 6) use the conic ends 29 with the left-hand helical flighting 30 and right-hand helical flighting 31 that grip and pull the stalk and introduce it between the rolls 32, the helical fightings 30 & 31 rotation and the new incoming stalks 34 avoid the plant from reaching out and force it to continue incoming through the rolls. The header forward movement and the gathering chains are also part of this process.

The issues related to the conic ends are associated with the operational area and the building area, the latter has to do, first with the fact that when the roll is not a single-piece cast, the conic ends with the helical flightings are pieces separated from the roll body, that must be cast or forged and then assembled to the roll body by welding or threading. In their building, helical flightings should not have sharp edges; they must be left-hand helical flightings and right-hand helical flightings and operate, with the other adjacent roll, in a properly out-of-phase and synchronized manner.

When cast, the conic ends and helical flightings add weight to the rolls, they must be smoothed and sometimes mechanized to avoid contact between rolls, those that are welded add qualified manpower and the materials utilized are softer than the casting by which they must be treated to increase its harshness and avoid premature wear.

The operational area presents many issues. If the helical flighting is too high, it does not allow an adequate incoming of the stalk by “pushing it”, this also takes places if the passage is narrow or if the helical flightings of one roll are not properly out-of-phase from the helical flightings of its adjacent roll, which may cause them to come into contact or close enough to cause stalk cut or incoming difficulty. If the helical flighting pitch is wide, the helical flightings function as drivers, capable of cutting the stalk, and if the revolutions are high, being overlapped, they form a “solid” panel, similar to that of fan blades, avoiding the incoming of stalks; this pushing produces a shearing effect causing the gathering chains to cut off the stalks or to break them up so that they fall on the header producing jamming or entering the combine harvester without being processed. If the helical flighting are too low or the cone is too acute, they lose traction, remaining the stalk entrance between the rolls in charge of the gathering chains and the forward movement of the header.

In order to accomplish stage “b”, the lateral rolls 28 use flutes, drivers or gears-like teeth 33 in the roll body 32, that when overlapping, they grasp and pull the stalk downwardly, at this point, in order to accomplish stage “c”, those that remove the crop head over the rolls differentiate over those that utilize stripper plates . The former must have little aggressive traction surfaces with rounded edges or teeth so that they do not “bite” or hurt the ear causing seed loss making them prone to wearing, which, when it takes place, considerably decreases the traction effect, and thus the ears do not separate appropriately from the stalk being then beaten by the gathering chains and thus producing seed loss and stalk breakage that is sent to the inside of the combine harvester. For this reason, in order to assure traction, the aggressiveness of the rolls is increased using mainly high-wing intercrossed drivers, which makes them less prone to wearing but does not allow contact between the ear and the rolls surface since it would probably mutilate it instead of separating them, pulling it downwards. In order to avoid this, the systems use a set of stripper plates that protect the ear from the rolls when removing the crop head. This may be problematic due to different stalks and ear sizes, which forces to constant adjustment of the stripper plate edges distance since when they are too far apart, they would not have a good grip of the ears and can this to pass through, and when too tight, the stalks would get stuck with consequences over the pushing of the plants (stalk cuts and breakage). Also, either way, an increase in the rolls rotation speed would make the overlapped drivers or flutes edges forms a solid panel thus hindering movement or producing stalk cut.

In a configuration as the one shown in FIG. 7, transverse rolls 35 in the present invention comply with the three stages as follows:

The front faces 36 of the opposite rolls 35 make the chamber “B” 39. The plants enter into the chamber “B” 39 due to the header forward movement and the gathering chains operation. Once inside chamber “B” 39, the plant reaches its rear part, which is with the front faces 36 of the opposite transverse rolls 35. At this point, the rotation of the upper part of the opposite rolls 35 moves in the same forward movement as the plants 37, which causes it to be stuck and forced to move to chamber “A” 40, when the side walls of chamber “B” 39 tighten the stalk and pull it downwards. Once the stalk is located in chamber “A” 40, it begins to be pulled by the opposite rolls side faces 38, pushing the stalk against the rear wall 41 of chamber “A” 40, the main requirement of the rear wall 41 of chamber “A” 40 is low-friction coefficient and high wear-proof and its shape will be the most adequate to the rolls variable geometry. Stuck between the side faces 38 and the rear wall 41, the stalk begins to go downwards with no possibility to return due to the little passage between the rolls 35, the rotation of the opposite rolls 35 and the new incoming stalks 42. While going downwards, the ear touches the top of the rear wall 41 and gets stuck against the side faces 38 that continue to pull the stalk downwards while rotating, until it removes the ear.

These stages show the functioning principle of transverse rolls in one of their possible configurations, its building is simple, and they function neither engaged nor synchronized. Because the transverse rolls are rotating piece allows for an easy mechanization, its functioning does not require 90° gearboxes or fine adjustments, and can be done through transmission belts, thus lowering building costs and equipment weight. An increase in rotation speed instead of hindering the movement of incoming plants increases its speed towards the inside of chamber “A” 40. The rear wall 41 of chamber “A” 40 may be built with wear-proof material, which can be easily replaced once reaching its end-of-life. The side face 38 can be also made of wear-proof material, which can be replaced once reaching its end-of-life without having to replace the entire roll 35.

Also, an increase in traction is described in FIGS. 8 and 9 due to the use of transverse rolls with flexible bands.

We notice in FIG. 8, that in the opposite rolls 43, the front faces 44 pressure reaches its maximum closeness in the “A1” point 45, after this point, the pressure lowers until it becomes null and the stalk traction is achieved through the friction with the surfaces being in contact with the stalk, which are the side faces 46 of the opposite rolls 43 with the side faces of normal rolls or the fixed anti-friction surface (not shown in FIG. 8). This traction transition between the front faces 44 to the side faces 46 is really quick, possibly causing a skid between the stalk and the rolls 43 until the stalk downward speed levels to that of the rolls 43 tangential speed.

In the opposite rolls with flexible bands of FIG. 9, the front faces 47 traction is prolonged by the side faces 48 of the flexible bands 49 from the “A2” point 50 up to the “B1” point 51, this causes the traction period to extend in time allowing the plant to beat its own inertia and gain speed downwards without causing a skid between the stalk and the rolls, being the entire surface of the transverse normal roll or the fixed anti-friction surface (not shown in FIG. 9) and the top of the flexible bands of the opposite rolls in contact with the stalk prior to its release out of the closure of the flexible band internal faces 48 in the “B1” point 51.

Also, both flexible bands 49 in their descent remain close to each other producing a curtain 52, as indicated in FIG. 9 that separates the stalk being processed behind, from the weed or stalk residue that may enter from the front. Anything that comes in contact with the curtain 52 from the front part, is forced to go downwards, the only thing that is able to enter the work zone behind the curtains are the elements coming from above, that is, unprocessed stalks, straightened by row divider points and gathering chains, or tall weed, this reduces the possibility of jamming and allows the stalk that is being processed, to reach the ground with the least amount of interference since the curtain 52 clears its way in its forward movement.

In the lateral rolls of the prior art, see FIG. 11, front face 53 does not fulfill any function, to the point of being covered by a conic end 54 whose function is to lead the plant towards the side face 55 in order to be pulled.

Some conic ends 54 have helical flightings 30 & 31 to favor the entrance of plant between the side faces 55, but this job is mainly done by the gathering chains which effectively force the entrance of plant to the lateral rolls system.

The front faces 56 in opposite transverse rolls 57, FIG. 12, are in charge of forcing the plant to enter into the work zone of the side faces 58, the way in which the front faces 56 compress and force the entrance of the plant has already been described in detail in the system functioning but it is worth mentioning that they do not need helical flightings nor the help of gathering chains to perform that job, thus favoring the entrance of plant and initiating its downward movement until it is continued by the side faces 58.

In other word, among the advantages of the transverse rolls over the lateral rolls of the prior art, we can mention the following:

Since they are rotation pieces, their building is simple (see example of four rolls FIGS. 20 to 22).

The transverse rolls diameter are not limited by the distance between rows as it is the case with lateral rolls, a larger diameter implies less rotations to pull the entire plant downwardly.

In the lateral rolls, by increasing its rotation speed, the overlapping flutes or drivers edges begin to form a “solid” impenetrable panel hindering the plants forward movement. This hinders the performance of gathering chains and row divider points to enter the plants into the system, producing a shearing effect between the gathering chains and the plants thus causing ear loss due to their downfall or to greater amount of material to be processed by the combine harvester. In the transverse rolls system, the transverse rolls rotation accompanies the plants progress inside the system by which the increase of rotation speed does not hinder their progress.

An increase in the harvest speed implies a greater amount of plants to be processed by the system. The process increase can be achieved in two ways: by increasing the speed of rotation and/or the rolls diameter; this is not limited in the transverse rolls system as it is in the lateral rolls system according to the previous two items.

The separation of the ear from the plant is produced at a certain point near the consolidating auger. This reduces the loss of ear on the ground and the gathering chains shearing effect.

Being the normal transverse rolls or fixed anti-friction surface are faced to the relative progress of the plants and weeds, they cannot pile up over the equipment at the end of the trajectory since they are pulled downwards when they come into contact with the side faces of the transverse rolls, this is because the opposite rolls and the new plants and weeds that enter the system push the previous ones ensuring the traction. In the lateral rolls system there is a blind spot at the rear end where the material that has not been pulled by these may pile up, causing jamming, which must be withdrawn manually resulting in a loss of time.

The lateral rolls system operate in a synchronized manner, a loss of synchrony would cause contact of the flutes or drivers edges or helical flightings, causing serious damage to the system thereby requiring adjustments in precision and 90° gearboxes for its correct operation. The transverse rolls system does not necessarily require synchrony in its functioning, thus the working of the opposite rolls 101 can be achieved by means of the normal roll 102 (by friction or engaged as shown in the 2-roll configuration in FIG. 26), by transmission belts 90 (as shown in the 4-rolls configuration in FIGS. 20 to 22) among other working modes and thus there is no need for adjustments in precision or 90° gearboxes which results in lower cost of production and maintenance.

By using smoother or less aggressive rolls, the separation of the crop head from the plant can be made directly on them, thereby making unnecessary the use of stripper plates.

The lateral rolls have helical flightings all along their surfaces or in their front ends to make possible the plants entrance and their trajectory between the rolls. In a pair of lateral rolls, the rotation between rolls is opposite, this implies that the helical flightings must be left-hand helical flightings and right-hand helical flightings and also the rolls must be left-hand rolls and right-hand rolls, thereby increasing the cost of manufacturing and spare parts. The transverse rolls do not require helical flightings to make possible the plants entrance and its trajectory between the rolls thus a single roll type may function as normal or opposite roll (see the four-rolls configuration). This produces lower manufacturing costs and lower amount of spare parts.

All these advantages allow corn headers to be built with few moving parts, lighter weight, low maintenance cost, greater harvest speed and reduced grain loss.

### BRIEF DESCRIPTION OF FIGURES

So as to make the object of the present invention more intelligible, it has been illustrated with design figures of its desired mode of realization, which act as demonstrative examples, as follows:

FIG. 1 illustrates a prior art disposition of the rolls;

FIG. 2 shows the first preferred mode of implementation of the present invention;

FIG. 3 shows a second preferred mode of implementation of the present invention;

FIG. 4 shows a third preferred mode of implementation of the present invention;

FIGS. 5a to 5d are part of a comparison between the system of lateral rolls of the prior art and the transverse rolls of the present invention.

FIG. 6 shows a lateral view and cross-section view of the prior art lateral rolls;

FIG. 7 shows a lateral view and a cross-section view of the transverse rolls according to the present invention;

FIG. 8 shows a cross-section view of the opposite transverse rolls according to a preferred mode of implementation of the present invention;

FIG. 9 shows the presence of flexible bands in rolls from FIG. 8;

FIG. 10 shows a lateral view and cross-section view of a generic roll;

FIG. 11 shows both a view from above and a cross-section view of the prior art lateral rolls;

FIG. 12 shows both a view from above and a cross-section view of the rolls of the present invention;

FIGS. 13 to 15 show the detailed functioning for a single-roll configuration according to the present invention;

FIGS. 16a to 16d show the detailed functioning for the configuration of three-rolls according to the present invention;

FIGS. 17 to 19 show different designs of rolls placed in a corn header according to the present invention;

FIGS. 20 to 22 show a lateral view, cross-section cuts, and upper and lateral views of a configuration of four identical transverse rolls with counter-rotation by transmission belts.

FIG. 23 shows a transverse rolls configuration with flexible bands;

FIGS. 24a and 25a show a system of transverse rolls without normal transverse roll;

FIGS. 24b and 25b show a system of opposite rolls with flexible bands;

FIGS. 24c and 25c show a system of opposite rolls with flexible bands;

FIG. 26 shows a variant of the transverse rolls system in a two-roll configuration;

FIG. 27 illustrates a configuration of transverse rolls positioned adjacent to the two front lateral rolls;

FIG. 28 shows a variant of the three-transverse rolls system of different shape and diameter and variable geometry;

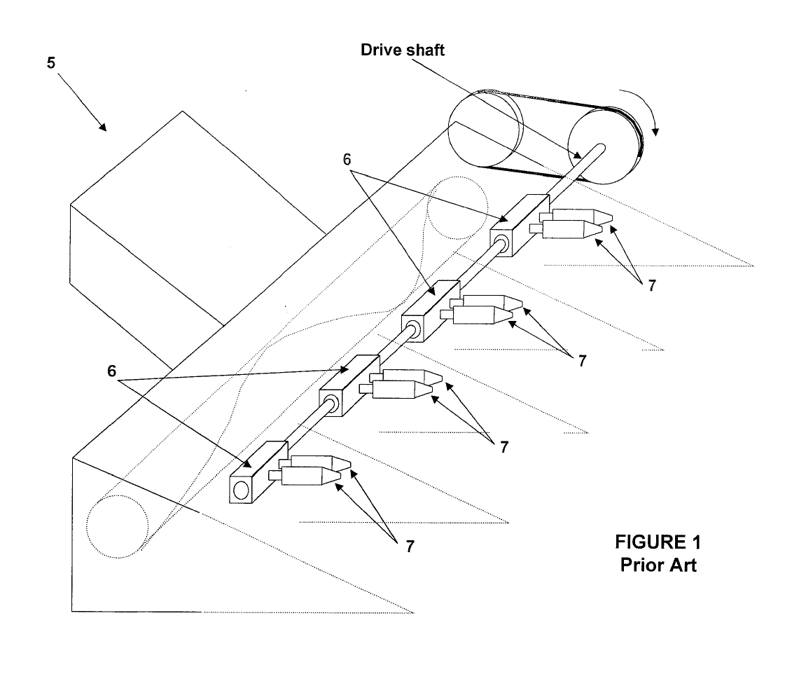

It is worth noticing that equal references of the figures correspond to equal elements of the invention.

### DETAILED DESCRIPTION OF THE INVENTION

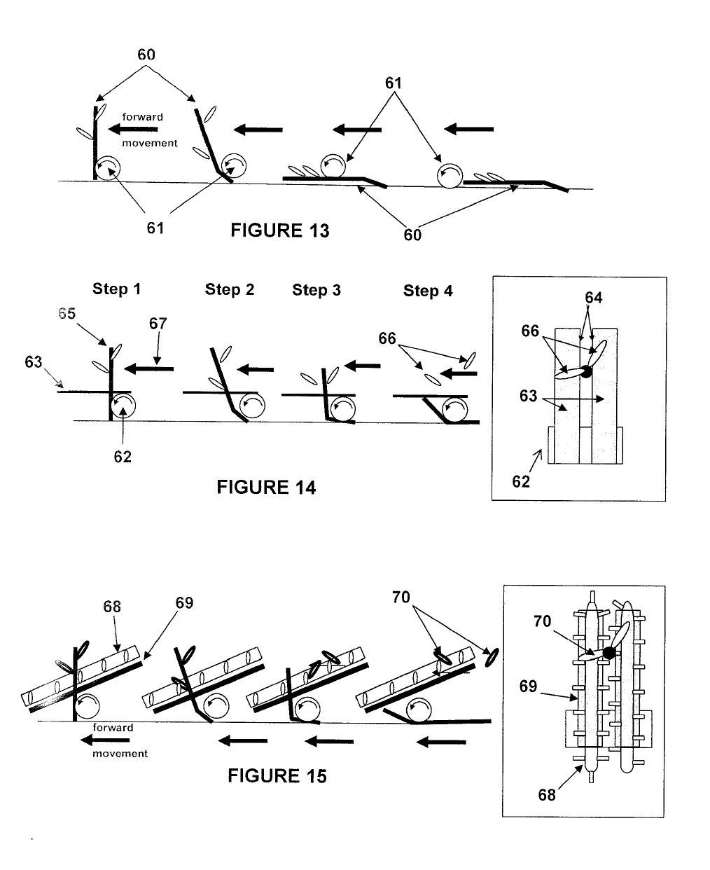

In order to explain the transverse roll operational principle, FIG. 13 shows the way as a normal transverse roll moves over a corn plant.

In the detailed operational description, of the one-roll configuration the sequence shows how the plant with the crop heads 60, it bends and moves underneath the roll 61 with no difficulties and without causing the roll 61 to drag over the plant 60. In the sequence of FIG. 14, the transverse roll 62 is assembled, in its upper part, with a set of stripper plates 63, the distance between the edges 64 of the stripper plates 63 allows the plant 65 but not the crop heads 66 to pass through.

The operational sequence of FIG. 14 is the following:

The plant 65 enters the system by passing through the stripper plates 63 without any hindrances until it comes in contact with the transverse roll 62.

In this moment begins the traction of the plant 65 towards the ground between the stripper plates 63 due to the rotation and the pressing of the roll 62 over the plant 65 and against the ground. In its downward movement, the plant 65 may bend in the forward-like direction 67 of the system but it is always contained by the stripper plates 63 that are long enough to avoid the plant 65 escape, and do not let the ears 66 to pass between them. There is no such dragging of the plant 65 against the ground because it is stuck between the ground and the roll 62. At this point the roll 62 may rotate by the dragging of the system over the ground or the roll 62 may be self-propelled to ensure it rotates over the plant 65 avoiding it to skid over it.

The ears 66 make contact with the stripper plates 63 and this produces their separation from the plant 65.

The plant 65 is pulled downwards following its descent between the stripper plates 63, passing underneath the roll 62 until they are left over the ground practically uncut, the ears 66 are dropped on the stripper plates 63 ready to be gathered.

The system of stripper plates for the separation of ears from the plant has been duly tested since it is already being used in current harvesting systems.

This description shows in a simple way the transverse rolls system operation principle for the pulling and separation of the ears from the corn plant in which the three principles previously stated are met. In actual practice, a wide range of situations arise such as fallen or cut plants unable to conveniently enter the system or the piling of ears and plant residue over the stripper plates that must be entered into the combine harvester for its processing.

Thus, conventional headers feature a system of gathering chains 68 (FIG. 15) over the stripper plates 69, which are in charge of gathering plants on the field and leading the remaining crop heads 70 and plants over the stripper plates 69 inwardly into the combine harvester.

The transverse rolls with rotation movement which allows them to move in the same forward-like fashion as that of the header, as shown in FIG. 13, are called normal transverse rolls.

The normal transverse roll rotation speed operating against the ground depends on the combine harvester ground speed, at a low ground speed, the plant is lowered more slowly and in softer soils, the rolls tends to sink or bog down. To free the normal roll rotation speed from the header forward movement, it must be detached from the ground thereby causing loss of traction over the plant. In order to keep the traction over the plant, it is necessary to use at least an extra transverse roll but rotating counter-rotating as regards the normal roll. These rolls with inverse rotation as regards the normal rolls are called rolls rotating in opposite direction or opposite rolls.

The function of the opposite rolls is pulling the plant inwardly between its side faces and the side face of the normal roll to pull it downwards towards the ground and separate ear from the plant if used as replacement of stripper plates.

The 16a, 16b, 16c and 16d sequence show in detail the way this takes place in a three-roll configuration:

Even though the plants are attached to the ground and what actually moves is the header, in order to clearly explain how the system works, it is relatively considered that the plants “enter” or “move towards” the rolls system, this relative movement is caused by the forward movement of the header, the pulling effect of the gathering chains on the plants towards the inside of the system and the rotation direction of the opposite rolls. First, the pulling down effect of the transverse rolls is described:

The sequence above shows the opposite rolls 71 rotating in an opposite-direction to the normal roll 72, the opposite rotation of the opposite rolls 71 causes their upper section 73 to move in the same forward-like movement as the plants and the lower section 74 to move opposite to the upper section. Opposite rolls 71 conform between them, in the front section, an opening angle, which allows the plants to pass between them, while the opening in the rear section is minimum allowing a crushed plant to pass without cutting it.

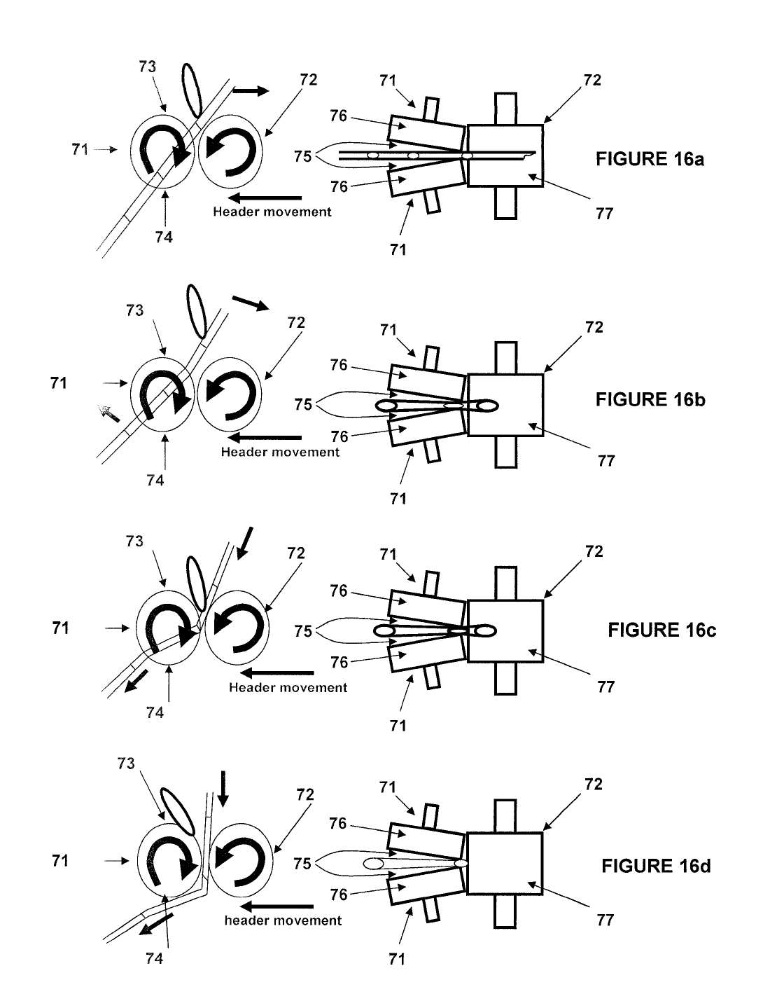

As the plant moves forward between the front faces 75 of the opposite rolls 71, this space begins to close until the plan gets stuck (FIG. 16a), this binding is caused in the upper section 73 as well as in the lower section 74 of the opposite rolls 71 but the rotation direction causes that, in the upper section 73 of the opposite rolls 71, the plant continues advancing inside the system, binding more and more between the front faces 75, which increases traction, while in the lower section 74 of the rolls 71, the plant is forced towards the front opening, decompressing, therefore not producing the pulling of the plant (FIG. 16b). The upper section 73 of the opposite rolls 71 holds the plant. While these rotate, their upper section 73 movement accompanies the forward plant movement, without offering resistance, so that the plant is driven and forced to enter between the side faces 76 of the opposite rolls 71 and the side face 77 of the normal transverse roll 72 (FIG. 16c) which pull it downwards and from where it has no chance of returning due to the counter-like rotation (hindering their coming back), to the reduced space remaining between them (the plant enters in a “crushed” manner, in a forward-like direction but once inside it is crushed in a transversal manner by the three side faces) and the plants that are entering. (FIG. 16d), the stalk, held by the three side faces of the transverse rolls 71 & 72, is forced to go through downwards completely until it lies on the ground.

Second, the crop head separating process is described:

In order for the plant to go through the rolls faces 76 & 77 (FIG. 16a & b), it must be crushed by them until it fits in the space between the rolls 71 & 72, such binding is possible because of its hollow stalk and the lateral forces applied by the transverse rolls 71 & 72 bind it and crush the stalks as it moves between them ensuring traction. On the other hand, the ear is tough, not hollow, which makes it difficult to crush and it has a bottom section diameter much larger than that of the stalk, this bottom part or the ear is joined to the stalk by means of a small stalk branch which is weaker than the stalk itself, thus when the ear, in its downward movement, touches the upper section of the rolls 71 & 72 and stops (FIG. 16c), it is unable to go through them while the stalk still moves on and pulls against the ear causing the cutting off of the small stalk branch and the separation of the ear (FIG. 16d), falling then in the consolidating auger from where it is taken to the inside of the combine harvester to be processed.

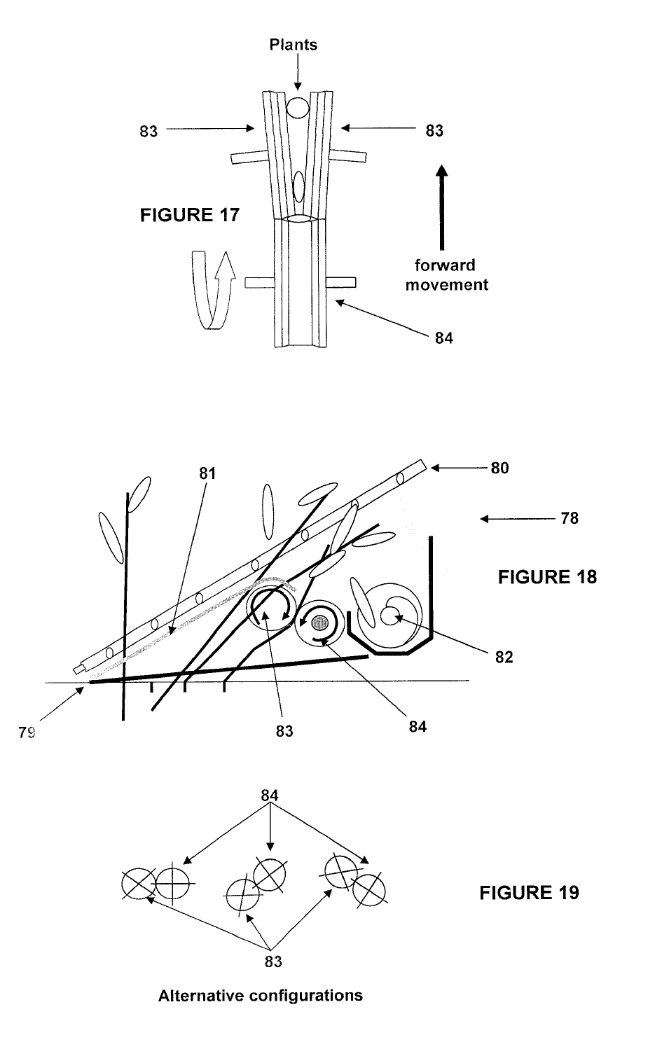

FIGS. 17, 18 and 19 show a design of how the rolls can be situated in a corn header.

FIG. 18 shows a system of transverse rolls assembled to a classic corn header 78, with row divider points 79, gathering chains 80, stripper plates 81 and consolidating auger 82. This configuration shows that the opposite rolls 83 axes and the normal roll 84 axis are not at the same level but inclined towards the consolidating auger 82, the same as the stripper plates 81, which curve over the rolls following their shape causing the plants to enter the system of rolls underneath the gathering chains 80 and over the consolidating auger 82 avoiding the ears to fall outside the header 78 and the gathering chains 80 to shear the plant before it is completely processed by the rolls 83 & 84 and in case the plant is sheared earlier this will fall over the consolidating auger 82, avoiding possible loss from plants and ears slippage over the gathering chains 80 towards the ground causing grain loss.

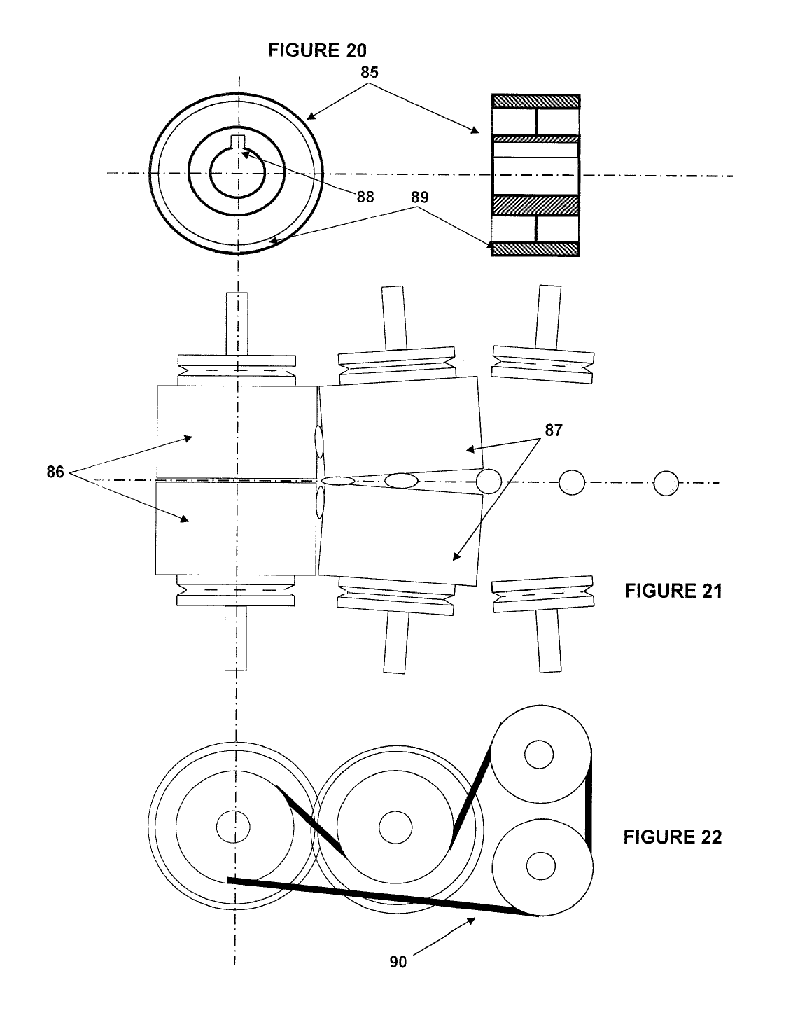

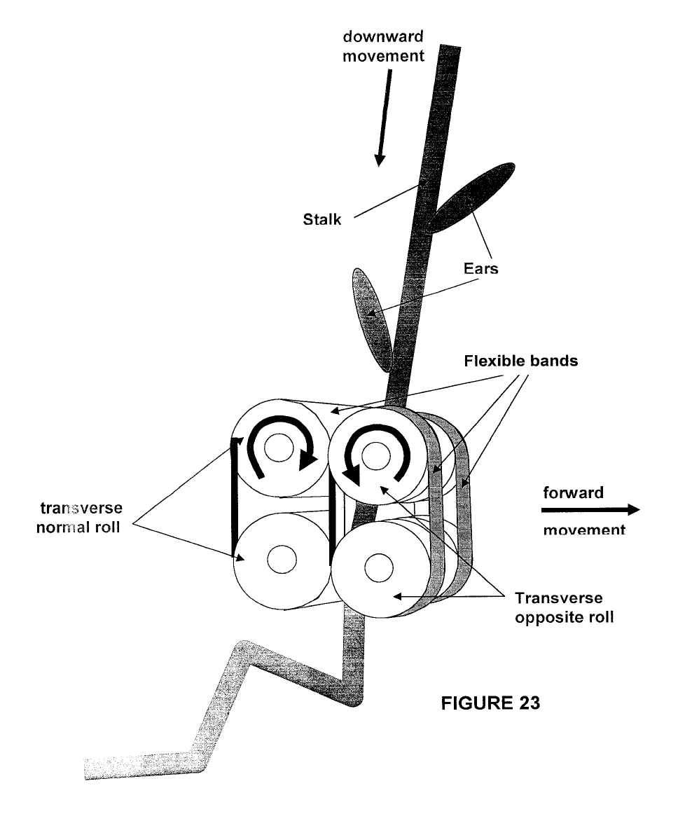

In the configuration of four identical transverse rolls with counter rotation by transmission belts of FIGS. 20, 21, and 22, only one type of roll 85 is used which functions as normal 86 and opposite roll 87, as can be seen in the figure, its building is simple, similar to that of a flat pulley with a key seat 88 which has a tread 89 in its outer side consisting of replaceable wear-proof plates or pieces, made of metal or rubber allowing lower-cost materials for the building of the core and adapting of the surface to the type of plant to be process (corn or sunflower).

Since the rotation of the transverse rolls is not necessarily synchronized, this configuration uses a transmission belt 90 in order to reverse the rotation of the opposite rolls 87, which simplifies and lowers the costs of the manufacturing process due to the fact that it does not need gears thereby causing fuel and maintenance savings.

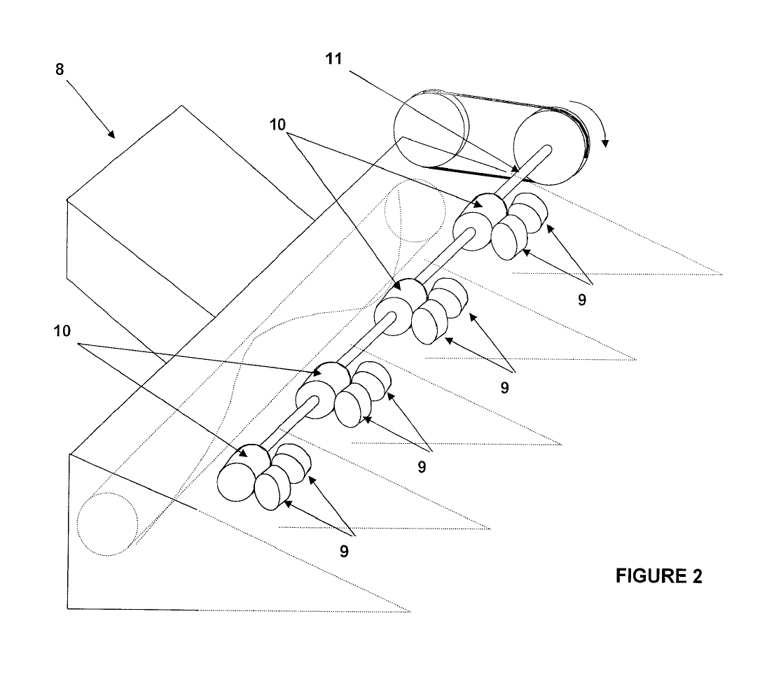

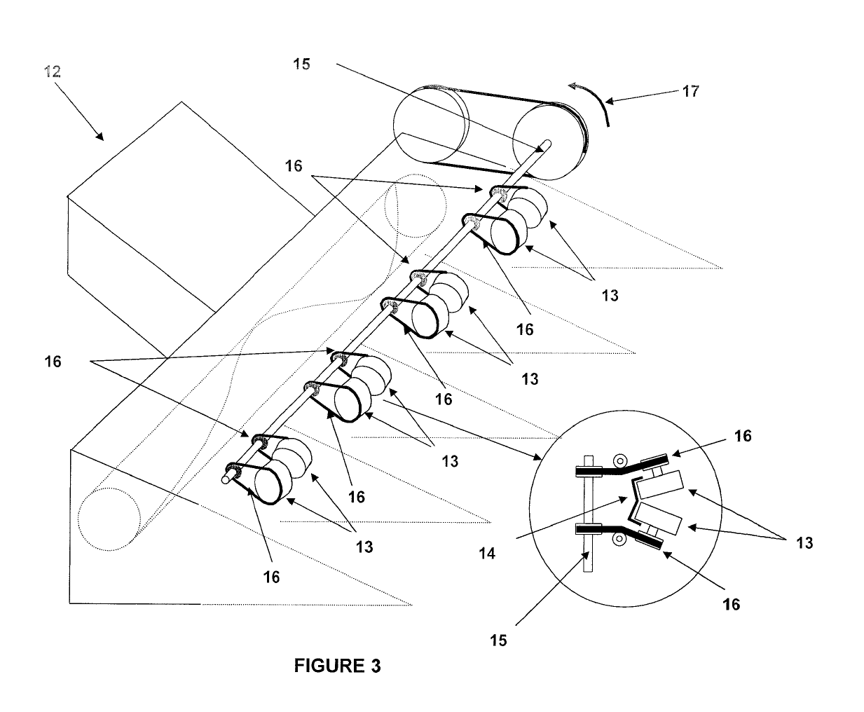

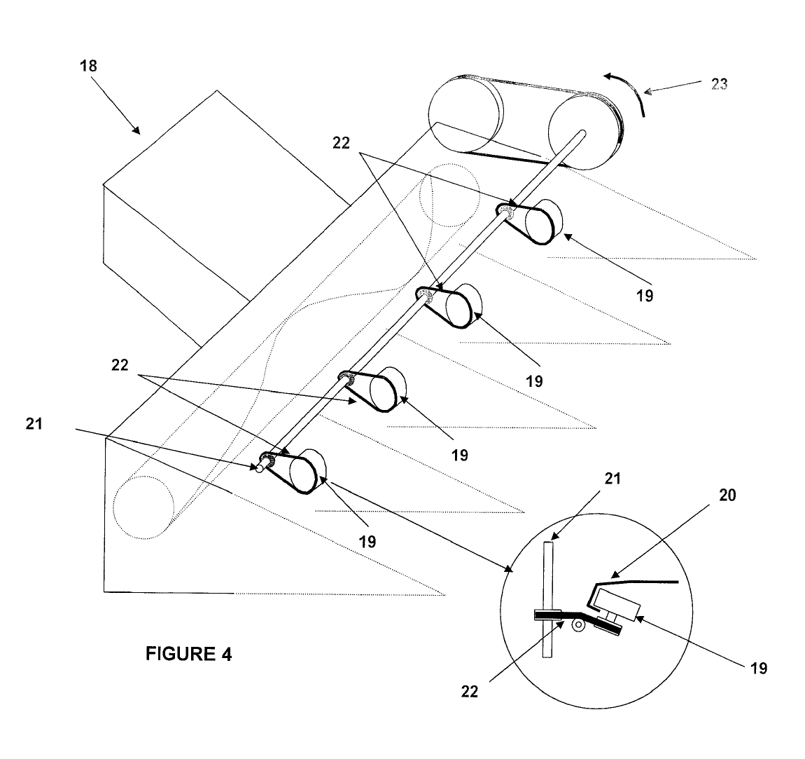

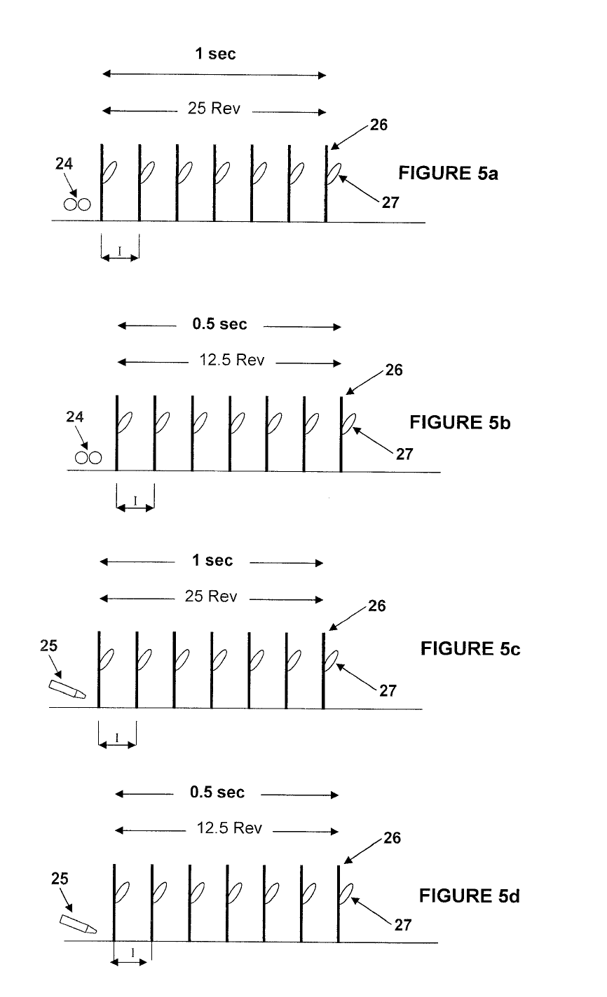

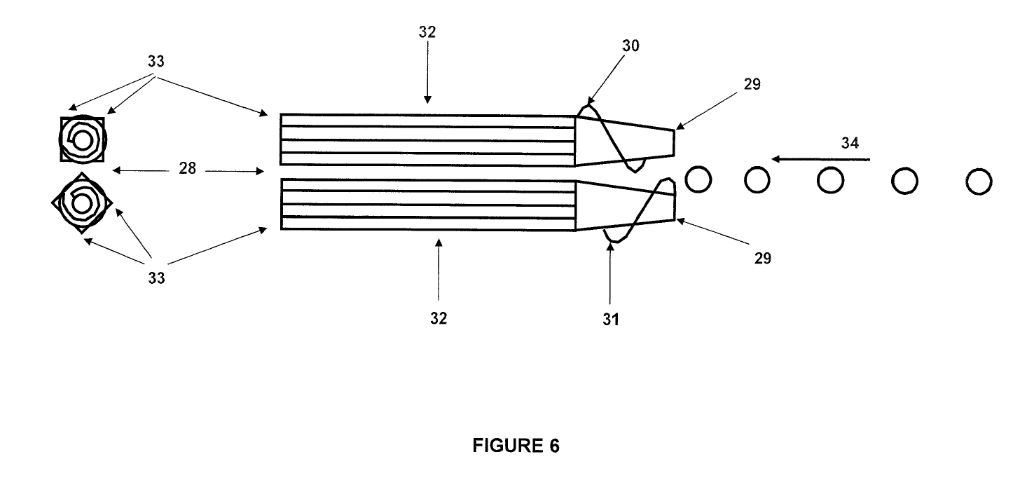

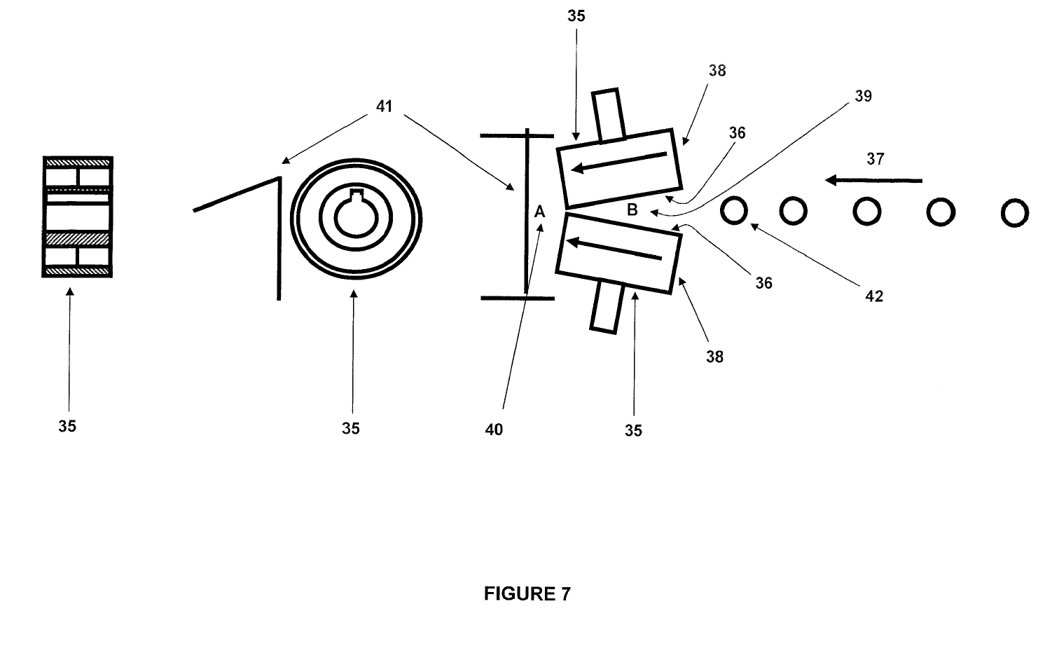

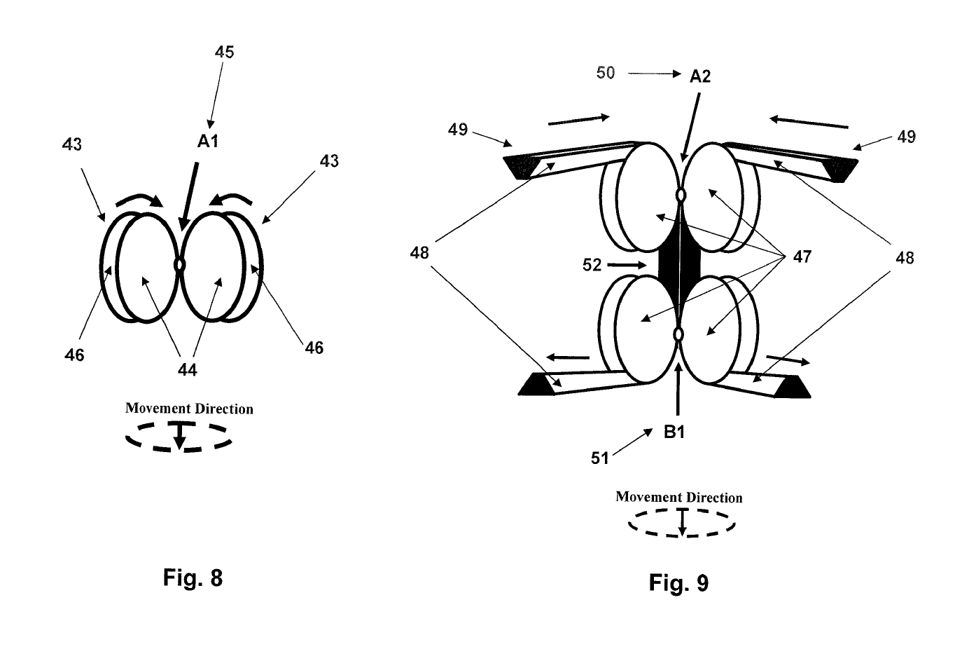

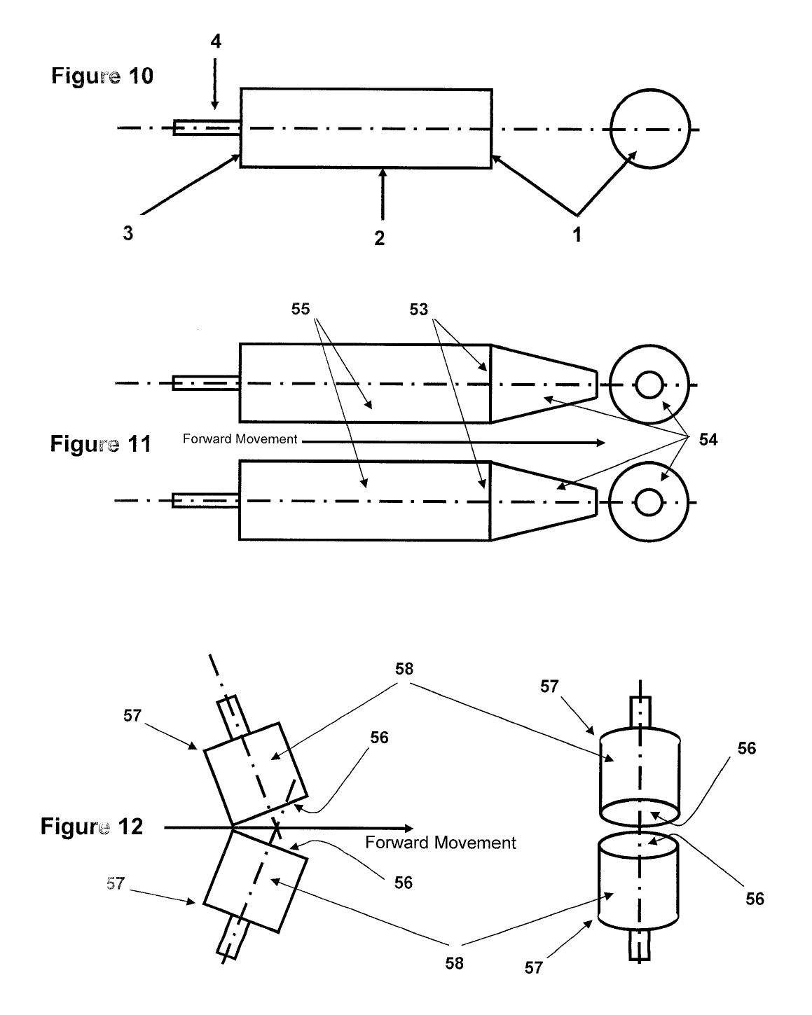

All normal transverse rolls are assembled over a common shaft connected directly to the header drive shaft (as in FIG. 2), without 90° gearboxes as the lateral rolls system; the absence of 90° gearboxes reduces building manpower and assembling in its manufacturing and required low energy in it operation to move the system and header weight which increases fuel saving.

The system of transverse rolls may be used to process the plants, to separate the crop heads or both simultaneously, if it is used to separate the crop heads, the aggressiveness of the rolls surface must be slight, preferably without flutes or drivers that hurt the ear causing grain loss; in order to guarantee traction, the rolls diameter may be enlarged increasing the contact surface between the plant and the rolls, this diameter increase is limited since with large diameters, the crop head may be crushed by the rolls without producing the crop head separation. Another way to increase the contact surface between the plant and the rolls system lies in using sets of transverse rolls and flexible bands, such as those previously explained which increases the contact surface which depends on the bands length and not necessarily on increasing the rolls diameter. The flexible bands may be single or multiple, metal chains, belts, rubber bands, etc. The rolls may feature V-shaped slots for V-belts, teeth for chains, slots for indented belts or they may be simply plain for plain belts for the flexible band dragging, all these elements have the advantage of being of easy construction or easy to obtain. Another system advantage is that plants and weeds tend to wrap around the rotation pieces such as the rolls, but since the flexible bands covers the rolls, these wrappings are no longer possible.

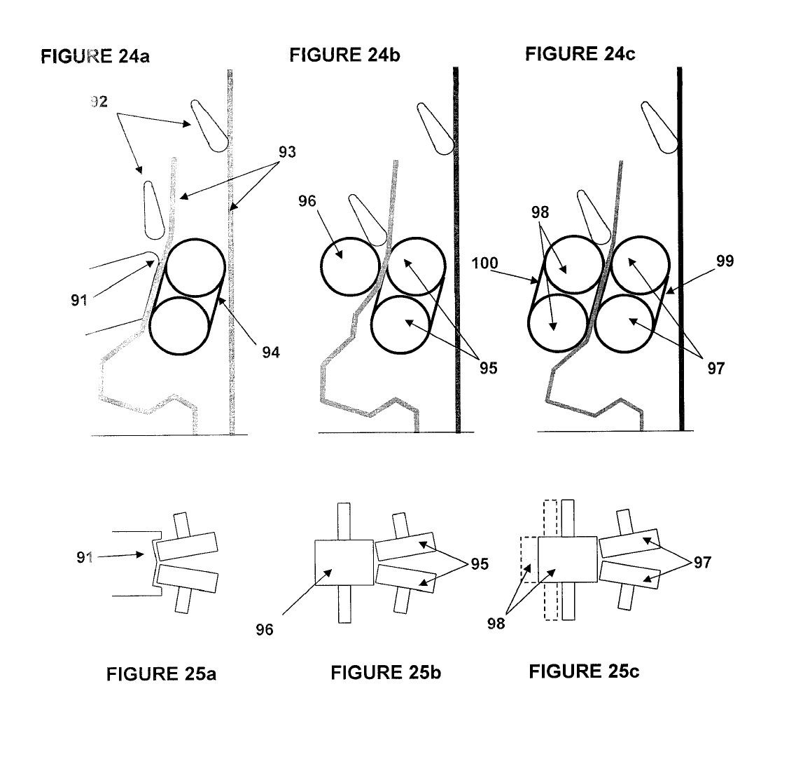

In FIGS. 24a, 24b, 24c, 25a, 25b, and 25c, we can see a configuration of transverse rolls with flexible bands. The uses of flexible bands increase traction over the plants, which allow the development of different configurations:

FIG. 24a & 25a shows a system of transverse rolls in which the normal transverse roll has been left out, the flexible bands 94 pressure against a sliding surface 91 with an adequate radius in its upper part to perform the separation of the crop head 92 from the plant 93.

FIG. 24b & 25b shows a system of opposite rolls 95 with flexible band performing against a normal transverse roll 96.

FIG. 24c & 25c shows a system of opposite rolls 97 with flexible bands 99 performing against a normal transverse roll 98 with flexible band 100.

Another variant of the transverse rolls system is the 2-roll configuration as follows:

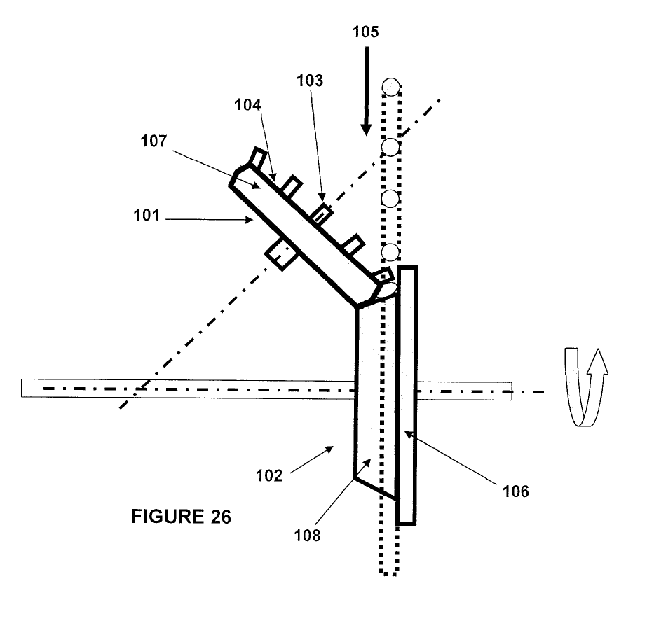

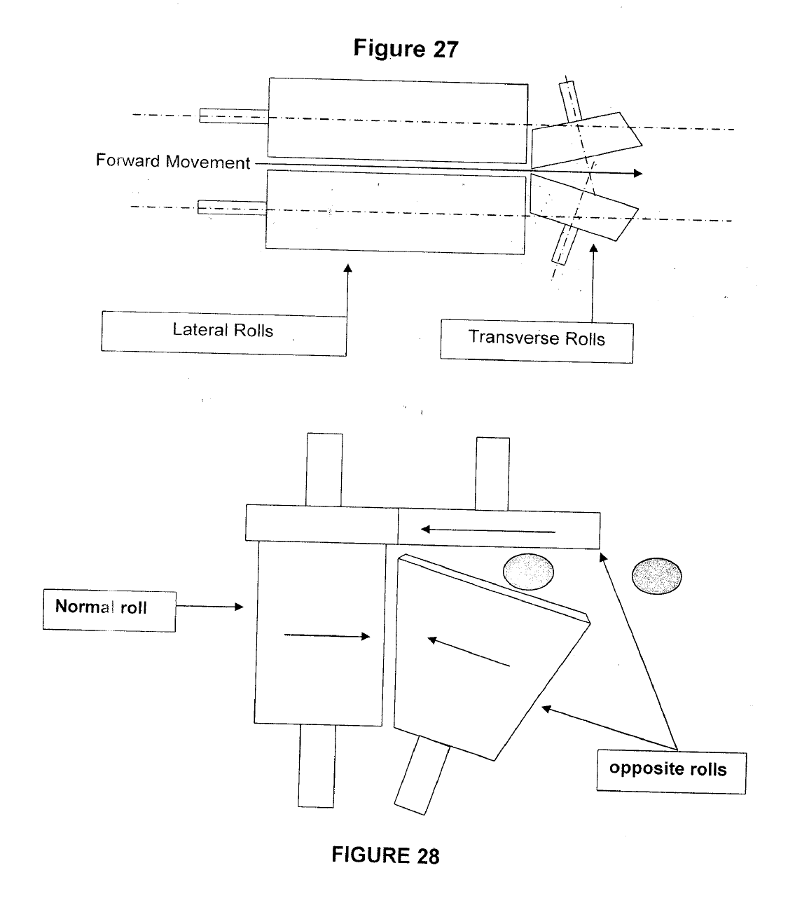

The design in FIG. 26 shows an example of a 2-rolls configuration in which the rotational movement of the opposite roll 101 results from the direct contact with the normal transverse roll 102 (E.g. metal-rubber contact, rubber-rubber and or gear teeth). As it can be noticed in the drawing, the synchronized rotation of the rolls is not necessary as in the case of current systems, in this case, the opposite roll 101 features an indentation 103 in its front face 104 to allow a better access of the plant 105 to the system. The plant is first trapped between the teeth 103 and the disk 106 positioned next to the normal transverse roll 102 (this disk 106 may or may not become part of the normal transverse roll 102) and then it is pulled by the opposite roll side face 107, its teeth 103 and the side face 108 of the normal transverse roll 102. This configuration shows that there is also a rotation of the upper section of the opposite roll 101 in the same direction as the relative plant forward movement 105 inside the system. Even though the upper section of the lateral disk 106 has an opposite movement to that of the plants forward relative movement 105, it does not offer resistance to that relative movement, since it has a smooth surface and by the time the plant is stuck between the opposite roll 101 and the disk 106, it already shows a downward movement which accompanies the teeth rotation of the opposite roll 101.

Generally speaking, the present invention consists in both a plants processor device and crop heads separator device for combine harvesters equipped with a row crop harvesting header with gathering zones at the front in which there are one, two, three or more rotating rolls, not necessarily with the same diameter or shape, where the rotational axes are positioned in a cross-like fashion to the combine harvester forward movement, that is, forming an angle as regards that forward movement and where at least one of them counter-rotates as regards the combine harvester forward direction and others do it in the same direction, not necessarily in a synchronized manner nor at the same speed; the function of the former is to introduce with their front faces the plants and the weeds between their side faces and the rolls side faces rotating in a forward direction where they are compressed and pulled downwards along with the crop heads. When these crop heads touch the upper section of the rolls, due to their shape and toughness, they do not pass between the rolls thus causing their separation from the plant by pulling, the plants and the weeds continue their downward movement between the rolls until they lie on the ground without entering the threshing system.

In one preferred mode, at least one of those rolls rotates in an opposite direction to the combine harvester forward movement and others rotate in the same direction, not necessarily in a synchronized fashion nor at the same speed, the rolls rotating in an opposite direction have the purpose of introducing plants and weeds with its front faces between their side faces and the rolls side faces rotating in a forward-like fashion where they are crushed and pulled downwards along with the crop heads, these crop heads do not touch the rolls but a set of stripper plates similar to the equipment currently used, positioned over the rolls with a distance between edges that allows only the stalks but not the crop heads to pass by. This allows for an increase in the roll system traction by means of an increase in their diameter, the use of the gear-like teeth, flutes or drivers, which are all quite aggressive toward the crop heads.

The opposite rolls will replace the front helical flightings of the lateral rolls known until today, for the incoming of the stalks to the pull-in area, lateral rolls have conic ends with left-hand helical flightings and right-hand helical flightings rotating in an accompanied and overlapped fashion, forcing the stalks to come in contact with them at entering between the rolls. The front faces of the opposite transverse rolls perform this function without offering resistance to the header forward movement or cutting the stalks by shearing them with the gathering chains or by abrasion produced by rotation of the helical flightings against the base of the stalk.

In another preferred mode, there will be a choice of transverse rolls with flexible bands, consisting in the use of sets of transverse rolls and flexible bands where the contact surface plant-roll depends on the length of the flexible bands and not on the rolls diameter. The flexible bands may be single or multiple, metal chains, belts or rubber bands.

In a preferred mode, at least one of the rolls with its rotational axis positioned in angle as regards the forward movement of the combine harvester will rotate in the combine harvester forward direction and the others (if any) will rotate opposite to the combine harvester forward direction.

We certify that what has been described and illustrated is only a preferred mode of implementation of the present invention and that any other implementation covered by the claims developed hereinafter will be considered included within its scope.

1-9. (canceled)

10. A plants processor and crop heads separator device for a combine harvesters comprising:
a row crop harvesting header having gathering zones;
wherein each gathering zone includes at least one rotating roll;
wherein the rotational axis of each rotating roll forms an angle in relation to the combine harvester forward movement.

11. The plants processor and crop heads separator device according to claim 10, wherein one of the rolls rotates in a forward direction with regards to the combine harvester.

12. The plants processor and crop heads separator device according to claim 10, wherein the device comprises at least two rolls and each of the rolls rotate at different revolutions.

13. The plants processor and crop heads separator device according to claim 10, wherein the device comprises at least two rolls and each of the rolls has different diameter with regard to the others rolls.

14. The plants processor and crop heads separator device according to claim 10, further comprising a set of stripper plates positioned over the at least one roll.

15. The plants processor and crop heads separator device according to claim 10, wherein the device further comprising transversal rolls having parallel rotational axes as regards to the forward movement of the combine harvester, wherein the transversal rolls are positioned adjacent and after the rolls which form an angle as regards the forward movement of the combine harvester.

16. The plants processor and crop heads separator device according to claim 15, further comprising flexible bands over the transversal rolls to transmit movement, wherein the transversal rools are in contact with the plant.

17. The plants processor and crop heads separator device according to claim 16, wherein the flexible bands are made up of metal chains.

18. The plants processor and crop heads separator device according to claim 16, wherein the flexible bands are made up of rubber belts.
